(19) United States
(12) Patent Application Publication
(10) Pub. No.: US 2007/0275361 A1
(43) Pub. Date: Nov. 29, 2007

(54) Individual Examination Execution Device

(76) Inventors: Tomoaki Tezuka, Osaka (JP); Katsuhiro Nakai, Hyogo (JP); Takehisa Hirano, Osaka (JP); Kouji Mukai, Kyoto (JP)

Correspondence Address: WENDEROTH, LIND & PONACK L.L.P., 2033 K. STREET, NW, SUITE 800, WASHINGTON, DC, 20006, US

(21) Appl. No.: 10/593,873

(22) PCT Filed: Mar. 11, 2005
(86) PCT No.: PCT/JP05/04355

§ 371 Date: Sep. 22, 2006

(30) Foreign Application Priority Data
Mar. 24, 2004 (JP) 2004-086022
Jun. 30, 2004 (JP) 2004-194408

(51) Int. Cl. G09B 3/00

(52) U.S. Cl. 434/351; 434/322; 434/350

(57) ABSTRACT

An individual examination execution device is provided with a question storage means (14) in which exam questions are stored, a sequence data holding means (12) that holds sequence data as a basis of exam question reproduction sequence, at sequence instruction means (13) for reading the exam questions stored in the question storage means (14), and a reproduction means (15) for reproducing the exam questions stored in the question storage means (14) into audio. The sequence instruction means (13) reads the exam questions stored in the question storage means (14) with reference to the sequence data stored in the sequence data holding means (12), and the exam question reproduction sequence is changed according to the seat position.

### TECHNICAL FIELD

The present invention relates to an individual examination execution device.

### BACKGROUND ART

In the conventional listening test in the “University Testing Center Examination” executed by the independent administrative institution, National Center for University Entrance Examinations, sound is reproduced from speakers placed in an examination room so that examinees in the examination room can listen to the sound simultaneously to answer questions. The examinees write the answers in computer-scoring answer sheets. In order to resolve inequality which is caused by environmental difference in the examination room, for example, difference in the degree of audibility to the reproduced sound, which depends on seat positions in the examination room, there has been considered an examination method using individual examination execution devices to which headphones or earphones are connected.

As for this technique, although a document to be cited as a prior art has not been found, there is a non-patent document as follows, and it is a well-known matter (for example, refer to non-patent document 1: newspaper article, Asahi Shimbun (morning edition) on Nov. 11, 2003, page 29).

### DISCLOSURE OF THE INVENTION

However, using the conventional individual examination execution devices, examinees answer the same exam questions in the same sequence at the same timing, whereby the examinees can easily find the positions of answers written on computer-scoring answer sheets, and therefore, dishonest acts are likely to occur. Further, although all the examinees simultaneously press play buttons on the individual examination execution devices to start examination at a cue of a test proctor, there is likely to occur unfairness that some examinee presses the play button of the individual examination execution device prior to the cue of the test proctor to know the exam questions. Further, if the battery power of some individual examination execution device is exhausted, examination is undesirably interrupted, and the examinee cannot answer the remaining questions.

Furthermore, during the listening test, there is likely to occur such dishonest act that some examinee takes a recording media out of the examination room and reproduces the questions using an equipment other than the individual examination execution device to let another person hear the questions and answer the same, and further, it is impossible to check whether a person taking the examination is an actual examinee or not. Furthermore, in the case where the examinees write the answers into the computer-scoring answer sheets, since the examinees leave the examination room after the answer sheets are collected, it takes much time to complete the examination.

The present invention is made to solve the above-mentioned problems and has for its object to provide an individual examination execution device which can prevent dishonest acts, and is not influenced by interruption of examination that depends on the remaining battery power, as well as an examination method using the device. Further, it is another object to provide an individual examination execution device which can speedily collect answers after examination is finished, and an examination method using the device.

In order to solve the above-mentioned problems, an individual examination execution device as defined in claim 1 of the present invention comprises a question storage means in which exam questions are stored; a reproduction means for reproducing the exam questions stored in the question storage means; and a sequence instruction means for instructing a reproduction sequence of the exam questions.

Further, according to claim 2 of the present invention, the individual examination execution device defined in claim 1 further includes a sequence data holding means for holding reproduction sequence instruction data to be given to the sequence instruction means.

Further, according to claim 3 of the present invention, the individual examination execution device defined in claim 1 further includes an individual number input means for inputting an individual number possessed by a user of the individual examination execution device; and a sequence data generation means for generating reproduction sequence instruction data to be given to the sequence instruction means, from the individual number.

Further, according to claim 4 of the present invention, the individual examination execution device defined in any of claims 1 to 3 further includes a time instruction means for giving an instruction of operation to the sequence instruction means; and a time data holding means for holding time data at which the time instruction means operates.

Further, according to claim 5 of the present invention, the individual examination execution device defined in any of claims 1 to 4 further includes an answer input means that is operable to input answers in association with reproduction of exam questions; and an answer storage means in which answer data generated by the answer input means are stored.

Further, according to claim 6 of the present invention, the individual examination execution device defined in any of claims 1 to 5 further includes a battery power monitoring means for monitoring the remaining power of battery that operates the individual examination execution device; and a progress degree storage means in which progress degree information of exam questions is stored when the remaining power of battery monitored by the battery power monitoring means becomes lower than a predetermined level.

Further, an individual examination execution device as defined in claim 7 of the present invention comprises an exam question storage means in which exam questions are stored; a reproduction means for reproducing the exam questions stored in the exam question storage means; an individual information storage means in which individual information is stored; and a display means for reading the individual information stored in the individual information storage means, and displaying the same.

Further, an individual examination execution device as defined in claim 8 of the present invention comprises an exam question storage means in which exam questions are stored; a reproduction means for reproducing the exam questions stored in the exam question storage means; an answer input means which is operable to input answers in association with reproduction of the exam questions; an answer storage means in which the inputted answers are stored; and a radio communication means for transmitting the answers stored in the answer storage means by radio.

Further, an individual examination execution device as defined in claim 9 of the present invention comprises an exam question storage means in which exam questions are stored; a reproduction means for reproducing the exam questions stored in the exam question storage means; an answer input means which is operable to input answers in association with reproduction of the exam questions; and a radio communication means for successively transmitting the answers that are inputted from the answer input means.

Further, an individual examination execution device as defined in claim 10 of the present invention comprises a unique number storage means in which a unique number that differs for each individual examination execution device is stored; an exam question storage means in which exam questions that are encoded according to the unique number are stored; a decoding means for reading the exam questions stored in the exam question storage means, and decoding the same; and a reproduction means for reproducing the decoded exam questions.

Further, according to claim 11 of the present invention, the individual examination execution device defined in claim 10 further includes an answer input means which is operable to input answers in association with reproduction of the exam questions; and an answer storage means in which the inputted answers are stored.

Further, an individual examination execution device as defined in claim 12 of the present invention comprises an exam question storage means in which exam questions are stored as protected information; a reproduction means for reproducing the exam questions stored in the exam question storage means; and a mutual authentication processing means for confirming that the exam question storage means and the reproduction means are a predetermined combination; wherein reproduction of the exam questions by the reproduction means is carried out when mutual authentication is confirmed by the mutual authentication processing means.

Further, according to claim 13 of the present invention, the individual examination execution device defined in claim 12 further includes a mutual authentication result display means for displaying the result of confirmation that the exam question storage means and the reproduction means are a predetermined combination.

Further, according to claim 14 of the present invention, there is provided an examination method using an individual examination execution device defined in any of claims 1 to 13.

According to claim 1 of the present invention, an individual examination execution device comprises a question storage means in which exam questions are stored; a reproduction means for reproducing the exam questions stored in the question storage means; and a sequence instruction means for instructing a reproduction sequence of the exam questions. Therefore, it is possible to reproduce the exam questions in a predetermined sequence.

Further, according to claim 2 of the-present invention, the individual examination execution device defined in claim 1 further includes a sequence data holding means for holding reproduction sequence instruction data to be given to the sequence instruction means. Therefore, it is possible to change the sequence of the exam questions to be reproduced.

Further, according to claim 3 of the present invention, the individual examination execution device defined in claim 1 further includes an individual number input means for inputting an individual number possessed by a user of the individual examination execution device; and a sequence data generation means for generating reproduction sequence instruction data to be given to the sequence instruction means, from the individual number. Therefore, it is possible to provide an individual number input type an individual examination execution device which reproduces the exam questions on the basis of the individual number.

Further, according to claim 4 of the present invention, the individual examination execution device defined in claim 1 further includes a time instruction means for giving an instruction of operation to the sequence instruction means; and a time data holding means for holding time data at which the time instruction means operates. Therefore, it is possible to provide an exam question automatic reproduction type individual examination execution device which automatically reproduces the exam questions at an expected time.

Further, according to claim 5 of the present invention, the individual examination execution device defined in any of claims 1 to 4 further includes an answer input means that is operable to input answers in association with reproduction of exam questions; and an answer storage means in which answer data generated by the answer input means are stored. Therefore, it is possible to provide an answer input type individual examination execution device in which answers to the exam questions are directly inputted.

Further, according to claim 6 of the present invention, the individual examination execution device defined in any of claims 1 to 5 further includes a battery power monitoring means for monitoring the remaining power of battery that operates the individual examination execution device; and a progress degree storage means in which progress degree information of exam questions is stored when the remaining power of battery monitored by the battery power monitoring means becomes lower than a predetermined level. Therefore, it is possible to provide a battery power monitoring type individual examination execution device which monitors the remaining power of battery.

Further, according to claim 7 of the present invention, an individual examination execution device comprises an exam question storage means in which exam questions are stored; a reproduction means for reproducing the exam questions stored in the exam question storage means; an individual information storage means in which individual information is stored; and a display means for reading the individual information stored in the individual information storage means, and displaying the same. Therefore, an exam proctor can easily judge whether a person sitting in a seat where the individual examination execution device is placed is an actual examinee or not, thereby preventing a dishonest act by a substitute examinee.

Further, according to claim 8 of the present invention, an individual examination execution device comprises an exam question storage means in which exam questions are stored; a reproduction means for reproducing the exam questions stored in the exam question storage means; an answer input means which is operable to input answers in association with reproduction of the exam questions; an answer storage means in which the inputted answers are stored; and a radio communication means for transmitting the answers stored in the answer storage means by radio. Therefore, the time until completion of examination can be reduced by collecting the answers with radio communication.

Further, according to claim 9 of the present invention, an individual examination execution device comprises an exam question storage means in which exam questions are stored; a reproduction means for reproducing the exam questions stored in the exam question storage means; an answer input means which is operable to input answers in association with reproduction of the exam questions; and a radio communication means for successively transmitting the answers that are inputted from the answer input means. Therefore, it becomes unnecessary to provide each examinee with an answer storage means such as a computer scoring answer sheet, and the time until completion of examination can be reduced.

Further, according to claim 10 of the present invention, an individual examination execution device comprises a unique number storage means in which a unique number that differs for each individual examination execution device is stored; an exam question storage means in which exam questions that are encoded according to the unique number are stored; a decoding means for reading the exam questions stored in the exam question storage means, and decoding the same; and a reproduction means for reproducing the decoded exam questions. Therefore, it is possible to prevent such dishonest act that some examinee takes out the recording media and lets another person hear the exam questions to obtain answers.

Further, according to claim 11 of the present invention, the individual examination execution device defined in claim 10 further includes an answer input means which is operable to input answers in association with reproduction of the exam questions; and an answer storage means in which the inputted answers are stored. Therefore, it is possible to prevent such dishonest act that some examinee takes out the recording media and lets another person hear the exam questions to obtain answers. Further, since the examinee is not requested to submit the memory card itself in which answers are stored, the examinee can take the memory card home to use it for self-scoring, whereby the precision of self-scoring can be improved, and the time until the examinee selects a school for which he/she takes entrance exam can be reduced.

Further, according to claim 12 of the present invention, an individual examination execution device comprises an exam question storage means in which exam questions are stored as protected information; a reproduction means for reproducing the exam questions stored in the exam question storage means; and a mutual authentication processing means for confirming that the exam question storage means and the reproduction means are a predetermined combination; wherein reproduction of the exam questions by the reproduction means is carried out when mutual authentication is confirmed by the mutual authentication processing means. Therefore, even when someone tries to reproduce the exam question storage means outside the examination room, since it is difficult to establish mutual authentication, it is impossible to reproduce the exam questions outside the examination room, thereby preventing such dishonest act that some examinee takes out the recording media and lets another person hear the exam questions to obtain answers.

Further, according to claim 13 of the present invention, the individual examination execution device defined in claim 12 further includes a mutual authentication result display means for displaying the result of confirmation that the exam question storage means and the reproduction means are a predetermined combination. Therefore, when reproduction of the exam questions is not carried out in the examination room, it is possible to judge whether the cause is malfunction of the device or incorrect combination, and thereby examination can be started speedily.

Further, according to claim 14 of the present invention, there is provided an examination method using an individual examination execution device defined in any of claims 1 to 13. Therefore, it is possible to achieve the effect of preventing dishonest acts, the effect of executing examination without delay, or the effect of speedily collecting answers after examination is finished.

### BRIEF DESCRIPTION OF THE DRAWINGS

FIG. 1 is a block diagram illustrating an individual examination execution device according to a first embodiment.

FIG. 2 is a diagram illustrating sequence data of the individual examination execution device according to the first embodiment.

FIG. 3 is a diagram illustrating seat positions and arrangement of individual examination execution devices in an examination room according to the first embodiment.

FIG. 4(a) is a top plan view of the individual examination execution device according to the first embodiment.

FIG. 4(b) is a rear side view of the individual examination execution device according to the first embodiment.

FIG. 4(c) is a rear side view of the individual examination execution device with a battery box cover being removed, according to the first embodiment.

FIG. 5 is a block diagram illustrating an individual examination execution device according to a second embodiment.

FIG. 6 is a top plan view of the individual examination execution device according to the second embodiment.

FIG. 7 is a block diagram illustrating an individual examination execution device according to a third embodiment.

FIG. 8 is a block diagram illustrating an individual examination execution device according to a fourth embodiment.

FIG. 9 is a top plan view of the individual examination execution device according to the fourth embodiment.

FIG. 10 is a block diagram illustrating an individual examination execution device according to a fifth embodiment.

FIG. 11 is a block diagram illustrating an individual examination execution device according to a sixth embodiment.

FIG. 12 is a block diagram illustrating an individual examination execution device according to a seventh embodiment.

FIG. 13 is a block diagram illustrating an individual examination execution device according to an eighth embodiment.

FIG. 14 is a block diagram illustrating an individual examination execution device according to a ninth embodiment.

FIG. 15 is a block diagram illustrating an individual examination execution device according to a tenth embodiment.

FIG. 16 is a block diagram illustrating an individual examination execution device according to an eleventh embodiment.

FIG. 17 is a block diagram illustrating an individual examination execution device according to a twelfth embodiment.

### DESCRIPTION OF REFERENCE NUMERALS

11a, 11b, 11c, 11d . . . individual examination execution device

12 . . . sequence data holding means

13 . . . sequence instruction means

14 . . . question storage means

15 . . . reproduction means

16, 16a . . . play button

17 . . . headphones

18 . . . memory card

19 . . . display unit

20 . . . volume setting button

20a . . . plus button

20b . . . minus button

21 . . . battery box cover

21a . . . battery box

22 . . . mode setting switch

22a . . . plus mode

23 . . . individual number input means

24 . . . sequence data generation means

25 . . . examinee's number input-button

25a . . . input button

25b . . . decision button

25c . . . delete button

25d . . . numerical button

26 . . . time data holding means

27 . . . time instruction means

28 . . . answer input means

29 . . . answer storage means

30 . . . answer input button

30a . . . decision button

30b . . . cancel button

30c . . . alphabetic button

31 . . . battery power monitoring means

32 . . . progress degree storage means

33 . . . warning light

101, 201, 301, 401, 501, 601, 701 . . . individual examination execution device

102, 602 exam question storage means

103, 603 reproduction means

104 . . . individual information storage means

105 . . . display means

106, 713 . . . display unit

107 . . . play button

108 . . . headphones

204, 304, 508 . . . answer input means

205, 509 . . . answer storage means

206, 305 . . . radio communication means

403 . . . unique number storage means

404 . . . decoding means

604 . . . first key information storage means

605 . . . second key information storage means

606 . . . first mutual authentication processing means

607 . . . second mutual authentication processing means

608 . . . protected information storage means

609 . . . normal information storage means

712 . . . mutual authentication result display means

### BEST MODE TO EXECUTE THE INVENTION

Hereinafter, embodiments of the present invention will be described with reference to the drawings.

### Embodiment 1

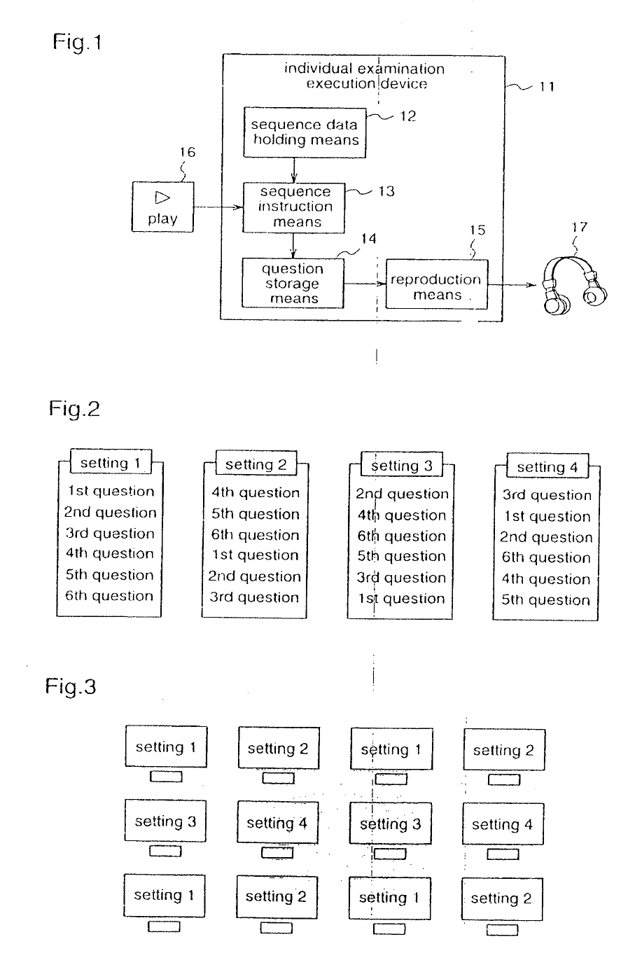

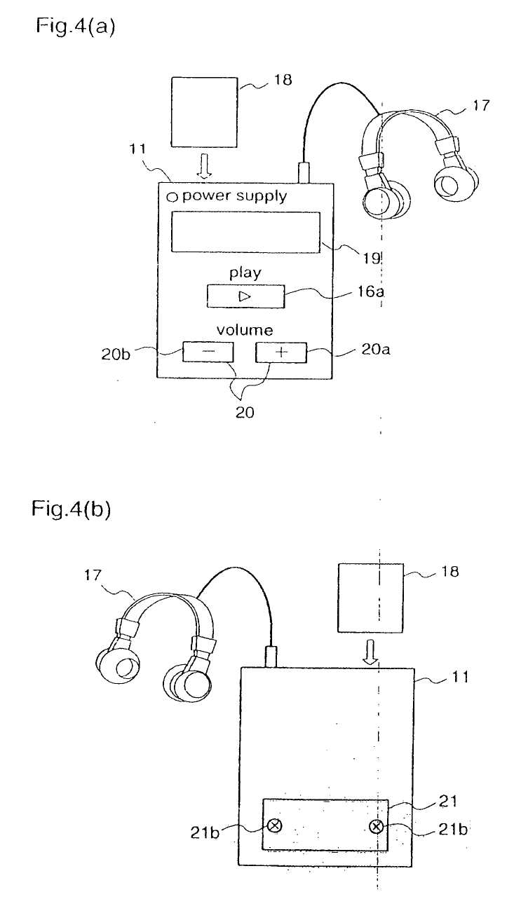

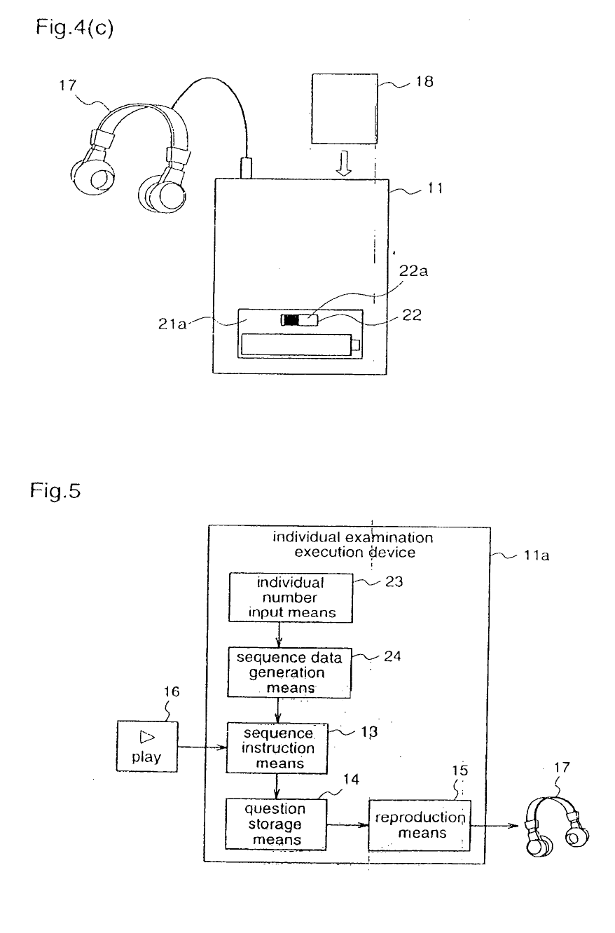

Initially, a description will be given of a construction of an individual examination execution device according to a first embodiment of the present invention, with reference to FIGS. 1 and 4. FIG. 1 is a block diagram of an individual examination execution device according to the first embodiment of the present invention, FIG. 4(a) is a top plan view of the individual examination execution device, FIG. 4(b) is a rear view of the individual examination execution device, and FIG. 4(c) is a rear view of the individual examination execution device with a battery box cover being removed

With reference to FIG. 1, reference numeral 11 denotes an individual examination execution device according to the first embodiment, and a sequence data holding means 12, a sequence instruction means 13, a question storage means 14, and a reproduction means 15 are provided in the individual examination execution device. A play button 16 and headphones 17 are connected to the sequence instruction means 13 and the reproduction means 15, respectively.

Further, the more detailed construction of the individual examination execution device 11 according to the first embodiment mainly includes, as shown in FIGS. 4(a), 4(b), and 4(c), a play button 16a, a display unit 19, a volume setting button 20, and a mode setting switch 22. A memory card 18 is inserted in the individual examination execution device, and headphones 17 is connected thereto.

The question storage means 14 stores exam questions in the individual examination execution device 11. The sequence data holding means 12 holds data indicating a reproduction sequence of the exam questions (hereinafter referred to as sequence data). The sequence instruction means 13 reads the exam questions stored in the question storage means 14, according to the sequence data. The reproduction means 15 outputs the exam questions stored in the question storage means 14 to the headphones 17.

The memory card 18 contains:the exam questions, and holds the sequence data indicating the reproduction sequence of the exam questions. That is, the memory card 18 corresponds to the question storage means 14 and the sequence data holding means 12.

The mode setting switch 22 performs setting as to which sequence data is to be used among the sequence data stored in the memory card 18, and it has a normal mode for executing examination and a sequence setting mode for setting a sequence of exam questions. When the mode setting switch 22 is set to a plus mode 22a to select the sequence setting mode, whereby the sequence of the exam questions can be set. When the mode setting switch 22 is set to a minus mode opposite to the plus mode 22a, the normal mode is selected. The mode setting switch 22 is disposed in the battery box 21a.

The volume setting button 20 is used for changing the sequence data, and it is provided with a plus button 20a and a minus button 20b After the mode setting switch 22 selects the sequence setting mode, the set number of the sequence data is increased by pressing the plus button 20a of the volume setting button 20, while the set number of the sequence data is decreased by pressing the minus button 20b, thereby the sequence data of the exam questions can be changed. The set number is displayed on the display unit 19, whereby the sequence data changing process is facilitated. That is, the mode setting switch 22 and the volume setting button 20 correspond to the sequence instruction means 13.

The play button 16a is used for reproducing the exam questions, and the exam questions are reproduced by one push, and the reproduction is stopped by one more push. The examinee can listen to the played exam questions with the headphones 17. That is, the play button 16a corresponds to the reproduction means 15.

Hereinafter, a description will be given of the operation of the individual examination execution device 11 according to the first embodiment constituted as described above, with reference to FIGS. 2 and 4. FIG. 2 shows an example of sequence data of the individual examination execution device according to the first embodiment.

Prior to execution of examination, as shown in FIG. 2, the exam questions from the first question to the sixth question are stored in the memory card 18, and the sequence data of four cases of settings from setting 1 to setting 6 in which the first to sixth questions are arbitrarily arranged are stored in the memory card 18.

Then, the memory card 18 in which the exam questions are stored and the sequence data are held is inserted into the individual examination execution device 11, and as shown in FIGS. 4(b) and 4(c), the battery box cover 21 is removed by slackening a screw 21b, and the mode setting switch 22 disposed in the battery box 21a is set in the sequence setting mode. Then, either the plus button 20a or the minus button 20b of the volume button 20 is pressed to read the sequence data stored in the memory card 18, and the reproduction sequence of the exam questions is set while monitoring the sequence data displayed on the display unit 19. After setting of the reproduction sequence of the exam questions is completed, the mode setting switch 22 is returned to the normal mode, and the battery box cover 21 is attached to the battery box 21a using the screw 21b. Since the battery box cover 21 is screwed onto the battery box 21a, it is possible to prevent the reproduction sequence of the exam questions from being changed by the examinee at liberty.

During execution of examination, when the play button 16 is pressed one time, the sequence instruction means 13 reads the exam question data stored in the memory card with reference to the sequence data stored in the memory card 18. The read exam question data are sent to the reproduction means 15 and reproduced, and thereafter, the exam questions are outputted as audio from the headphones 17. When the play button is pressed one more time, the reproduction is stopped.

The individual examination execution device 11 is used as follows. FIG. 3 is a diagram illustrating seat positions in an examination room and an example of arrangement of individual examination execution devices according to the first embodiment. The individual examination execution devices in which the exam questions and the reproduction sequences of the exam questions are set as shown in FIG. 2 are arranged in the examination, room so that the reproduction sequence of the exam questions in each seat position differs from those in the neighboring seat positions, as shown in FIG. 3. Thereby, examination can be executed.

As described above, the individual examination execution device according to the first embodiment of the present invention is provided with the question storage means 14 in which exam questions are stored, a reproduction means 15 for reproducing the exam questions stored in the question storage means 14, the sequence instruction means 13 for instructing the reproduction sequence of the exam questions, and the sequence data holding means 12 for holding the reproduction sequence instruction data to be given to the sequence instruction means 13. Therefore, a reproduction sequence of exam questions can be set for each individual examination execution device 11, thereby preventing such dishonesty that an examinee glances at answers that are entered by another examinee in the next seat.

Further, it is possible to execute fair examination by the examination method using the individual examination execution devices 11 according to the first embodiment of the present invention.

In this first embodiment, the number of sequence data and the number of exam questions to be stored in the individual examination execution device 11, and the seat positions in the examination room may be arbitrarily selected so long as the reproduction sequence of exam questions in each seat position differs from those in the neighboring seat positions, and therefore, the number of sequence data and the number of exam questions are not restricted to those shown in FIG. 2 while the seat positions are not restricted to those shown in FIG. 3.

Further, the specific construction of the individual examination execution device 11 is not restricted to the first embodiment of the present invention, and any construction may be adopted so long as it can hold exam questions, reproduce the exam questions according to a predetermined reproduction sequence, and hold the reproduction sequence.

### Embodiment 2

An individual examination execution device according to a second embodiment of the present invention is an individual number input type individual examination execution apparatus which is obtained by adding, to the individual examination execution device 11 of the first embodiment, an individual number inputting function by which an individual number possessed by a user of the individual examination execution device is entered, and exam questions are reproduced with reference to the individual number. The elements having the same or similar functions as/to those of the individual examination execution device 11 according to the first embodiment are given the same reference numerals to omit detailed descriptions thereof.

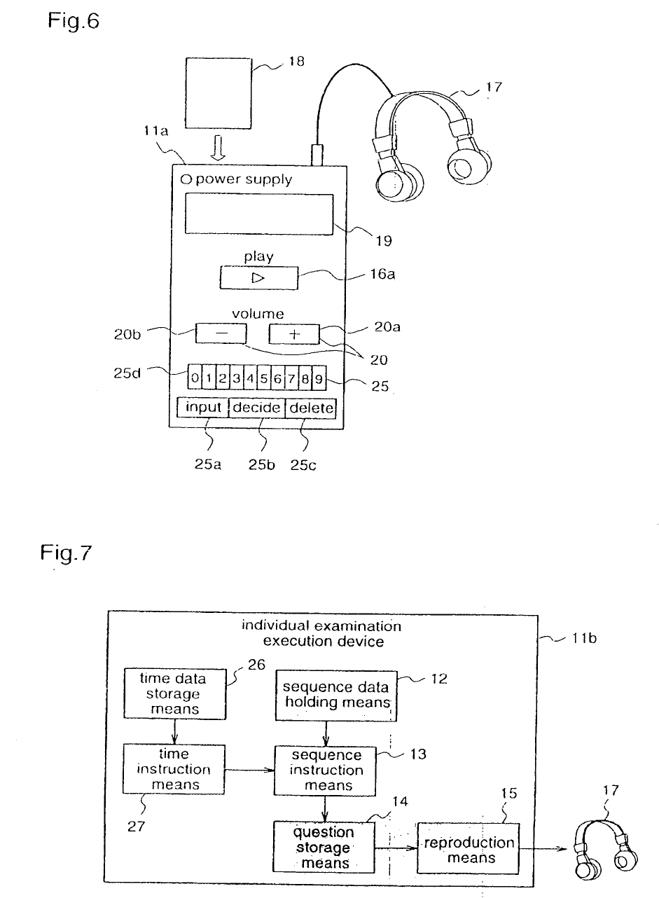

First of all, a description will be given of the construction of the individual examination execution device according to the second embodiment of the present invention, with reference to FIGS. 5 and 6. FIG. 5 is a block diagram of the individual examination execution device according to the second embodiment, and FIG. 6 is a top plan view of the individual examination execution device according to the second embodiment.

In FIG. 5, reference numeral Ha denotes an individual examination execution device according to the second embodiment, which includes an individual number input means 123, a sequence data generation means 24, a sequence instruction means 13, a question storage means 14, and a reproduction means 15. A play button 16 and headphones 17 are connected to the sequence instruction means 13 and the reproduction means 15, respectively.

Further, FIG. 6 shows a more detailed construction of the individual examination execution device 11a of the second embodiment. With reference to FIG. 6, the individual examination execution device 11a includes a play button 16a, a display unit 19, a volume setting button 20, and an examinee's number input button 25. A memory card 18 is inserted into the individual examination execution device 11a, and headphones 17 are connected thereto.

Accordingly, a description will be given if the individual number input means 23, the sequence data generation means 24, and the examinee's number input button 2, which are different from the constituents of the individual examination execution device 11 according to the first embodiment.

The individual number input means 23 is used for inputting an individual number, to which an individual number for setting as to which exam questions stored in the question storage means 14 is to be read, such as an examinee's number, is inputted.

The sequence data generation means 24 generates sequence data for setting a reproduction sequence of exam questions with reference to the examinee's number that is inputted to the individual number input means 23.

The examinee's number input button 25 is provided with an input button 25a, a decision button 25b, a deletion button 25c, and numerical buttons 25d by which numerals from 0 to 9 can be entered. The examinee presses the input button 25a, and thereafter, inputs the examinee's number by using the numerical buttons 25d. Since the examinee's number is outputted to the display unit 19, the examinee can visually check the inputted number After the examinee's number is inputted, the examinee presses the decision button 25b, whereby the examinee's number is decided, and a reproduction sequence of exam questions according to the examinee's number is set. The deletion button 25c enables the examinee to easily correct the examinee's number, whereby the examinee can delete incorrectly inputted numerals. That is, the examinee's number input button 25 corresponds to the individual number inputting means 23.

Hereinafter, a description will be given of the operation of the individual examination execution device 11a constituted as described above. Prior to execution of examination, the memory card 18 in which the exam questions are stored is inserted into the individual examination execution device 11a according to the second embodiment, like the individual examination execution device 11 according to the first embodiment. During execution of examination, when the examinee's number is inputted, the sequence data generation means 24 generates sequence data with reference to the examinee's number to decide the reproduction sequence of the exam questions, whereby preparation for reproduction of the exam questions is completed. When the examinee presses the play button 16a, the exam questions are outputted from the headphones 17. When the examinee presses the play button 16a again, the reproduction of the exam questions is stopped.

The individual examination execution device 11a according to the second embodiment is used as follows. The individual examination execution devices 11a in which the exam questions are set are placed in the examination room, in the same manner as described for the individual examination execution device 11 according to the first embodiment. Thereby, examination can be carried out.

As described above, the individual examination execution device 11a according to the second embodiment of the present invention is provided with the question storage means 14 in which the exam questions are stored, the reproduction means 15 for reproducing the exam questions stored in the question storage means 14, the sequence instruction means 13 for instructing the reproduction sequence of the exam questions, the sequence data holding means 12 for holding the reproduction sequence instruction data to be given to the sequence instruction means 13, the individual number inputting means 23 for inputting the examinee's number, and the sequence data generation means 24 for generating, from the examinee's number, reproduction sequence instruction data to be given to the sequence instruction means 13. Therefore, a reproduction sequence of the exam questions can be set for each examinee's number, thereby preventing such dishonesty that an examinee glances at answers that are entered by another examinee in the next seat.

Further, it is possible to execute examination in which the reproduction sequences of the exam questions are set with reference to the examinee's numbers, by the examination method using the individual examination execution devices 11a according to the second embodiment of the present invention.

In this second embodiment, the number of sequence data and the number of exam questions to be stored in the individual examination execution device 11a, and the seat positions in the examination room may he arbitrarily selected so long as the reproduction sequence of the exam questions in each seat position differs from those in the neighboring seat positions according to the examinee's numbers, and therefore, the number of sequence data and the number of exam questions are not restricted to those shown in FIG. 2 while the seat positions are not restricted to those shown in FIG. 3.

Further, the specific construction of the individual examination execution device 11a is not restricted to the second embodiment of the present invention, and any construction may be adopted so long as it can hold exam questions, reproduce the exam questions according to a reproduction sequence that is previously set with reference to an individually inputted examinee's number, and hold the reproduction sequence.

### Embodiment 3

An individual examination execution device according to a third embodiment of the present invention is an exam question automatic reproduction type individual examination execution device which is obtained by adding, to the individual examination execution device of the first embodiment, an exam question automatic reproduction function that automatically reproduces exam questions on a predetermined time. The elements having the same or similar functions as/to those of the individual examination execution device 11 according to the first embodiment are given the same reference numerals to omit detailed descriptions thereof.

First of all, a description will be given of the construction of an individual examination execution device 11b according to the third embodiment of the present invention, with reference to FIG. 7. FIG. 7 is a block diagram of the individual examination execution device according to the third embodiment.

In FIG. 7, reference numeral 11b denotes an individual examination execution device according to the third embodiment, which includes a sequence data holding means 12l, a sequence instruction means 13, a question storage means 14, a reproduction means 15, a time data holding means 26, and a time instruction means 27. Headphones 17 are connected to the reproduction means 15. Accordingly, only the time data holding means 26 and the time instruction means 27 which are not included in the individual examination execution device 11 of the first embodiment will be described.

The time data holding means 26 sets an examination start time, and holds the examination start time. The time instruction means 27 has a function equivalent to a play button, and reads the examination start time stored in the time data holding means 26 and automatically reproduces exam questions on the examination start time.

A description will be given of the operation of the individual examination execution device 11b according to the third embodiment which is constituted as described above. Prior to execution of examination, a memory card 18 in which the exam questions are stored, the sequence date is held, and the exam start time is held by the time data holding means 26 is inserted into the individual examination execution device 11b according to the third embodiment. When executing examination, the time indication means 27 reads the exam start time that is held by the time data holding means 26, and the exam questions are automatically outputted as audio from the headphones 17 on the set examination start time.

The individual examination execution device 11b according to the third embodiment is used as follows. Like the individual examination execution device 11 according to the first embodiment, the individual examination execution devices 11b according to the third embodiment in which the exam questions, the exam question reproduction sequences, and the examination start time are set are arranged in the examination room as shown in FIG. 3 so that the exam question reproduction sequence in each seat position differs from those in the neighboring seat positions. Thereby, examination can be executed.

As described above, the individual examination execution device 11b according to the third embodiment is provided with the question storage means 14 in which the exam questions are stored, the reproduction means 15 for reproducing the exam questions stored in the question storage means 14, the sequence instruction means 13 for instructing the reproduction sequence of the exam questions, the sequence data holding means 12 for holding the reproduction sequence instruction data to be given to the sequence instruction means 13 the time instruction means 27 for giving an operation instruction to the sequence instruction means 13, and the time data holding means 26 for holding the time data with which the time instruction means 27 operates. Therefore, the examinations can be simultaneously, started on the examination start time.

Further, according to the examination method using the individual examination execution devices 11b of the third embodiment, pre-listening of the exam questions can be avoided.

In this third embodiment, the number of sequence data and the number of exam questions which are stored in the individual examination execution device 11b, and the seat positions in the examination room may be arbitrarily selected so long as the exam question reproduction sequence in each seat position differs from those in the neighboring seat positions, and therefore, the number of sequence data and the number of exam questions are not restricted to those shown in FIG. 2, and the seat positions are not restricted to those shown in FIG. 3.

Further, the specific construction of the individual exam execution device 11b according to the third embodiment is not restricted to that of the third embodiment so long as the device can hold the exam questions, reproduce the exam questions on the basis of the predetermined examination start time and reproduction sequence, and hold the examination start time and reproduction sequence.

Furthermore, the individual number inputting function of the individual examination execution device 11a according to the second embodiment may be incorporated in the individual examination execution device 11b according to the third embodiment, and therefore, it is not restricted to the third embodiment.

### Embodiment 4

An individual examination execution device according to a fourth embodiment of the present invention is an answer input type individual examination execution device which is obtained by adding, to the individual examination execution device 11 of the first embodiment, an answer input function with which a user of the individual examination execution device directly inputs answers to exam questions that are reproduced from the individual examination execution device, into the individual examination execution device. The elements having the same or equivalent functions as those of the individual examination execution device 11 of the first embodiment are given the same reference numerals, and therefore, detailed descriptions thereof will be omitted.

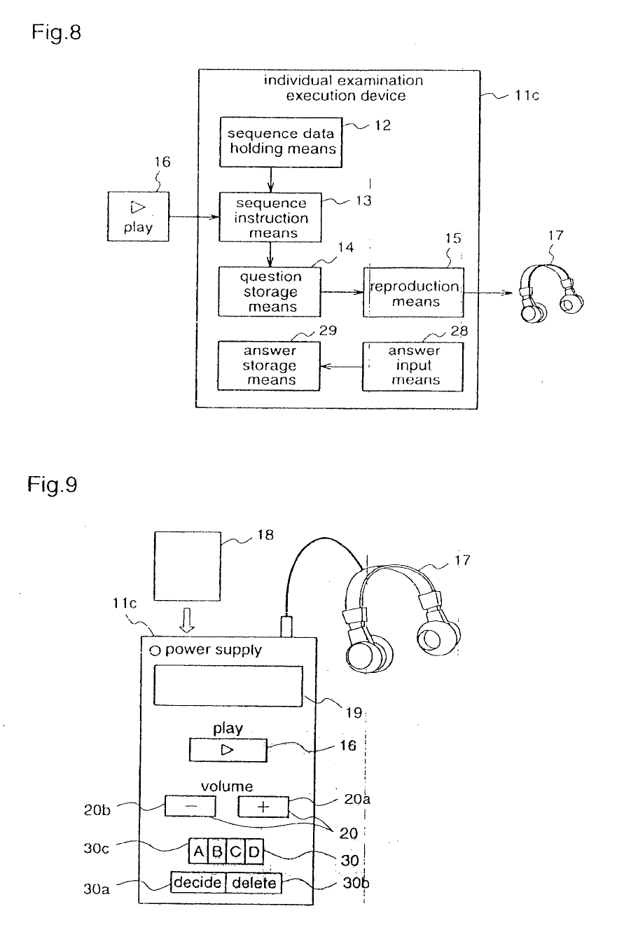

Initially, the construction of the individual examination execution device 11c according to the fourth embodiment will he described with reference to FIGS. 8 and 9. FIG. 8 is a block diagram of the individual examination execution device according to the fourth embodiment, and FIG. 9 is a top plan view of the individual examination execution device of the fourth embodiment.

With reference to FIG. 8, reference numeral 11c denotes an individual examination execution device according to the fourth embodiment, which includes a sequence data holding means 12, a sequence instruction means 13, a question storage means 14, a reproduction means 15, an answer input means 28, and an answer storage means 29. A play button 16 and headphones 17 are connected to the sequence instruction means 13 and the reproduction means 15, respectively.

Further, a more specific structure of the individual examination execution device 11c according to the fourth embodiment is implemented by, as shown in FIG. 9, a play button 16, a display unit 19, a volume setting button 20, and an answer input button 30, and a memory card 18 is inserted into and headphones 17 are connected to the individual examination execution device.

Accordingly, a description will be given of the answer input means 28, the answer storage means 29, and the answer input button 30 which are not included in the individual examination execution device 11 of the first embodiment.

The answer input means 28 has a function of inputting answers to the exam questions.

The answer storage means 29 stores the answers to the exam questions, which are inputted by the answer input means 28.

The answer input button 30 comprises a decision button 30a, a cancel button 30b, and an alphabetic button 310c with which alphabetic characters from A to D can be entered, and the user enters an answer by pressing the alphabetic but on 30c. The answer is displayed on the display unit 19 so that the user can check the entered answer. After inputting the answer, the answer is decided by pressing the decision button 30a. An incorrectly entered answer can be canceled by the cancel button 30b, whereby correction of the answer can be easily performed. That is, the answer input button 30 corresponds to the answer input means 28.

A description will be given of the operation of the individual examination execution device 11c according to the fourth embodiment. Prior to execution of examination, the memory card 18 in which the exam questions are stored and the sequence data is held is inserted into the individual examination execution device 11c of the fourth embodiment, as described for the individual examination execution device 11 of the first embodiment. When executing examination, the user presses the play button 16 one time, whereby the exam questions are outputted from the headphones 17. When the user presses the play button 16 one more time, the reproduction of the exam questions is halted. In parallel with the reproduction of the exam questions, the answers to the exam questions are inputted to the individual examination execution device 11c through the answer input means 28, i.e., the answer input button 30. The inputted answers are stored in the answer storage means 29, i.e., the memory card 18.

The individual examination execution device 11c according to the fourth embodiment is used as follows. As described for the individual examination execution device 11 according to the first embodiment, the individual examination execution devices 11c according to the fourth embodiment in which the exam questions and the exam question reproduction sequences are set are arranged in the examination room as shown in FIG. 3 so that the exam question reproduction sequence in each seat position differs from those in the neighboring seat positions. Thereby, the examination can be executed.

As described above, the individual examination execution device 11c according to the fourth embodiment is provided with the question storage means 14 in which the exam questions are stored, the reproduction means 15 for reproducing the exam questions stored in the question storage means 14, the sequence instruction means 13 for instructing the reproduction sequence of the exam questions, the sequence data holding means 12 for holding the reproduction sequence instruction data to be given to the sequence instruction means 13, the answer input means 28 that is operated in association with reproduction of the exam questions, and the answer storage means 29 in which the answer data generated by the answer input means 28 are stored. Therefore, reproduction of the exam questions in each individual examination execution device is carried out in a sequence different from that of reproduction of the exam questions in a next device, thereby preventing such dishonesty that an examinee glances at answers that are entered by another examinee in the next seat.

Further, in the examination method using the individual examination execution device 11c according to the fourth embodiment, examination can be carried out without using answer sheets.

In this fourth embodiment, the number of the sequence data and the number of the exam questions which are stored in the individual examination execution device 11c, and the seat positions in the examination room may be arbitrarily selected so long as the exam question reproduction sequence in each seat position differs from those in the neighboring seat positions, and therefore, the number of the sequence data and the number of the exam questions are riot restricted to those shown in FIG. 2, and the seat positions are not restricted to those shown in FIG. 3.

Further, the specific construction of the individual exam execution device 11c according to the fourth embodiment is not restricted to that of the fourth embodiment so long as the device can store the exam questions, hold the exam question reproduction sequence, reproduce the exam questions on the basis of the reproduction sequence, input answers to the reproduced exam questions, and hold the inputted answers.

Furthermore, the individual number inputting function of the individual examination execution device 11a according to the second embodiment, or the exam question automatic reproduction function of the individual examination execution device 11b according to the third embodiment, or a combination of these functions may be incorporated in the individual examination execution device 11c according to the fourth embodiment, and therefore, it is not restricted to the fourth embodiment.

### Embodiment 5

An individual examination execution device according to a fifth embodiment of the present invention is battery power monitor type individual examination execution device which is obtained by adding, to the individual examination execution device 11 according to the first embodiment, a battery power monitoring function for monitoring remaining battery power. The elements having the same or equivalent functions as those of the individual examination execution device 11 of the first embodiment are given the same reference numerates, and therefore, detailed descriptions thereof will be omitted.

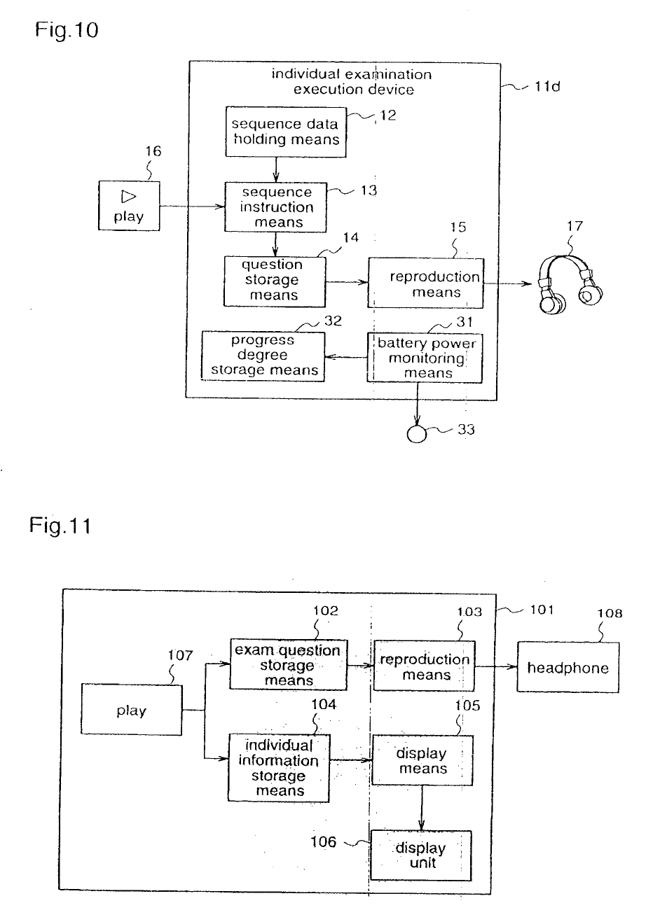

Initially, the construction of the individual examination execution device 11d according to the fifth embodiment will be described with reference to FIG. 10. FIG. 10 is a block diagram of the individual examination execution device 11d according to the fifth embodiment. With reference to FIG. 10, reference numeral 11d denotes an individual examination execution device according to the fifth embodiment, which includes a sequence data holding means 12, a sequence instruction means 13, a question storage means 14, a reproduction means 15, a battery power monitoring means 31, and a progress degree storage means 32. A play button 16 is connected to the sequence instruction means 13, headphones 17 are connected to the reproduction means 15, and a warning light 33 is connected to the battery power monitoring means 31. Accordingly, a description will be given of the remaining battery monitoring means 31 and the progress degree storage means 32 which are not included in the individual examination execution device 11 of the first embodiment.

The battery power monitoring means 31 monitors the remaining battery power, and turns on the warning light 33 when it is difficult to continuously use the individual examination execution device 11d with the remaining battery power.

The progress degree storage means 32 stores the answer positions of the answered exam questions. When the battery power monitoring means 31 decides that the remaining battery power is too small to continue the exam questions, the exam question answer position at this point in time is stored in the progress degree storage means 32, and the progress of the exam questions is stopped.

Hereinafter, a description will be given of the operation of the individual examination execution device 11d of the fifth embodiment constituted as described above. Prior to execution of examination, the memory card 18 in which the exam questions are stored and the sequence data is held is inserted into the individual examination execution device 11d of the fifth embodiment, as described for the individual examination execution device 11 of the first embodiment. During execution of examination, when the user presses the play button 16, the exam question data are reproduced and outputted from the headphones 1-7. Simultaneously with the reproduction of the exam questions, the battery power monitoring means 31 starts to monitor the remaining battery power. When the battery power monitoring means 31 decides that it is difficult to continue answering to the exam questions with the remaining battery power, the inputted exam question answer position is stored in the progress degree storage means 32, i.e., the memory card 18, and the warning light 33 is turned on to temporarily stop the examination.

The individual examination execution device 11d according to the fifth embodiment is used as follows. As described for the individual examination execution device 11 according to the first embodiment, the individual examination execution devices 11d according to the fifth embodiment in which the exam questions and the exam question reproduction sequences are set are arranged in the examination room so that the exam question reproduction sequence in each seat position differs from those in the neighboring seat positions, as shown in FIG. 3. Thereby, the examination can be executed. During execution of the examination, the battery power monitoring means 31 is operated simultaneously with reproduction or the exam questions. When the warning light 33 is turned on, the exam proctor takes the examinee in the seat position where the warning light 33 is turned on, to another room, and after battery change, examination is again started from the exam question answer position that is stored in, the progress degree storage means 32.

As described above, the individual examination execution device lid according to the fifth embodiment is provided with the question storage means 14 in which the exam questions are stored, the reproduction means 15 for reproducing the exam questions stored in the question storage means 14, the sequence instruction means 13 for instructing the reproduction sequence of the exam questions, the sequence data holding means 12 for holding the reproduction sequence instruction data to be given to the sequence instruction means 13, the battery power monitoring means 31 for monitoring the remaining battery power, and the progress degree storage means 32 in which information about the degree of progress of the exam questions is stored when the remaining battery power becomes smaller than a predetermined level. Therefore, the examination can be temporarily stopped when the remaining battery power becomes smaller than a predetermined level, and after resumption, the examination can be continued from the position where it was stopped.

Further, the remaining battery power can be checked before execution of examination by the examination method using the individual examination execution device 11d according to the fifth embodiment.

In this fifth embodiment, the number of the sequence data and the number of the exam questions which are stored in the individual examination execution device 11d, and the seat positions in the examination room may be arbitrarily selected so long as the exam question reproduction sequence in each seat position differs from those in the neighboring seat positions, and therefore, the number of the sequence data and the number of the exam questions are not restricted to those shown in FIG. 2, and the seat positions are not restricted to those shown in FIG. 3.

Further, the specific construction of the individual exam execution device 11d is not restricted to that of the fifth embodiment so long as the device can store the exam questions, hold the exam question reproduction sequence, reproduce the exam questions on the basis of the reproduction sequence, monitor the remaining battery power simultaneously with the reproduction of the exam questions, and store the exam, progress information according to the result of monitoring to temporarily stop the examination.

Furthermore, the individual number inputting function of the individual examination execution device 11a according to the second embodiment, or the exam question automatic reproduction function of the individual examination execution device 11b according to the third embodiment, or the answer input function of the individual examination execution device 11c according to the fourth embodiment, or a combination of these functions may be incorporated in the individual examination execution device 11d according to the fifth embodiment.

### Embodiment 6

FIG. 11 is a diagram illustrating the construction of an individual examination execution device according to a sixth embodiment of the present invention. In FIG. 11, reference numeral 101 denotes an individual examination execution device according to the sixth embodiment, which includes an exam question storage means 102 in which exam questions are stored, a reproduction means 103 for outputting the exam questions stored in the exam question storage means 102 to headphones 108, an individual information storage means 104 in which individual information is stored, a display means 105 for displaying, on a display unit 106, the individual information stored in the individual information storage means 104, and a play button 107 for generating a signal with which reproduction of the exam questions is started. Further, reference numeral 108 denotes headphones connected to the reproduction means 103.

Hereinafter, a description will be given of the operation of the examination method using the individual examination execution device 101 according to the sixth embodiment that is constituted as described above.

When the play button 107 of the individual examination execution device 101 is pressed, the exam question data stored in the exam question storage means 102 are read. The read exam question data are sent to the reproduction means 103, and outputted as audio to the headphones 108. Further, when the play button 107 is pressed, individual information, such as an examinee's head-and-shoulders photograph or an examinee's number, which is stored in the individual information storage means 104, is read simultaneously with the readout of the exam question data, and the individual information is displayed on the display unit 106 by the display means 105.

The individual examination execution device 101, the exam question storage means 102, and the display unit 106 can be easily implemented by using a semiconductor player, a memory card, and a liquid crystal display, respectively.

As described above, since the individual examination execution device according to the sixth embodiment is provided with the individual information storage means 104, the display means 105, and the display unit 106, the exam proctor can easily judge as to whether a person who is sitting in a seat where the individual examination execution device 101 is placed is an actual examinee or not, thereby preventing a dishonest act by a substitute examinee.

While in this sixth embodiment a semiconductor player is employed as the individual examination execution device 101, the individual examination execution device 101 is not restricted thereto, and it may be any device that can reproduce audio, such as a portable music player, besides a radio cassette player and a semiconductor player.

Further, while in this sixth embodiment a memory card is employed as the exam question storage means 102, the exam question storage means 102 is not restricted thereto, and it may be any media in which data can be stored, such as a hard disk or a mini disk.

Further, a liquid crystal screen is employed as the display unit 106, the display unit 106 is not restricted thereto, and it may be any display unit such as an organic EL display or a PDP (Plasma Display Panel).

### Embodiment 7

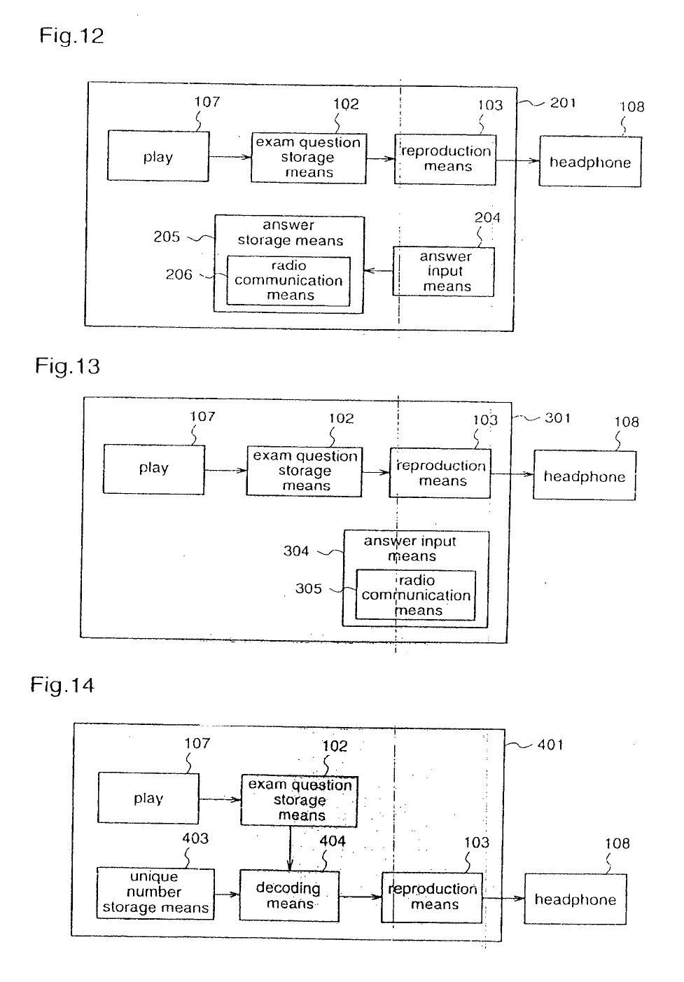

FIG. 12 is a diagram illustrating the construction of an individual examination execution device according to a seventh embodiment of the present invention. In FIG. 12, reference numeral 201 denotes an individual examination execution device according to the seventh embodiment, and the same reference numerals as those shown in FIG. 11 denote the same or corresponding parts. Reference numeral 204 denotes an answer input means for inputting an answer designated by an examinee into an answer storage means described later, and numeral 205 denotes an answer storage means including a radio communication means 206.

Hereinafter, a description will be given of an operation relating to an examination method using the individual examination execution device 201 according to the seventh embodiment.

When the play button 107 of the individual examination execution device 201 is pressed, exam question data stored in the exam question storage means 102 are read out. The read exam question data are transmitted to the reproduction means 103, and outputted as audio to the headphones 108. Further, answers to the exam questions are not written on in answer sheet such as a computer scoring answer sheet but are inputted as electric signals by the answer input means 204 to be stored in the answer storage means 205. Collection of the answers after the examination is carried out by transmitting the answers stored in the answer storage means 205 to a central processing unit (not shown) by the radio communication means 206.

It is possible to easily realize a system by using a semiconductor player as the individual examination execution device 201, and an IC card as the exam question storage means 102, the answer storage means 205, and the radio communication means 206. In this case, for example, an IC card reader is placed at the door way of the examination room, and the examinees hold the IC cards in which the answers are stored over the IC card reader when they exit the examination room, whereby the answers can be collected.

As described above, in the individual examination execution device according to the seventh embodiment of the present invention, the answers are not written in a computer scoring answer sheet but are stored in the individual examination execution device 201 itself, and the answers are collected by radio communication. Therefore, the time required until completion of the examination can be reduced.

While in this seventh embodiment an IC card is adopted as the answer storage means 205 and the radio communication means 206, an equipment that realizes these means is not restricted to an IC card, and any equipment may be employed so long as it has the data storage function and the radio communication function.

Further, while in this seventh embodiment semiconductor player is adopted as the individual examination execution device 201, an equipment that realizes the individual examination execution device 201 is not restricted thereto, and any equipment that can reproduce audio, such as a portable music player, may be adopted besides a radio cassette player and a semiconductor player.

### Embodiment 8

In the above-mentioned seventh embodiment, the time required until completion of examination can be reduced by recording the answers in the individual examination execution device and collecting the same by radio communication. However, in the individual examination executed by the device thus constituted, the examinee must bring the answer storage means to the device that reads the answers stored in the answer storage means.

An individual examination execution device according to an eighth embodiment of the invention improves is improved in this point. Hereinafter, the individual examination execution device will be described with reference to FIG. 13.

FIG. 13 is a diagram illustrating the construction of an individual examination execution device according to an eighth embodiment of the present invention. In FIG. 13, reference numeral 301 denotes an individual examination execution device according to the eighth embodiment, and the same reference numerals as those shown in FIG. 11 denote the same or corresponding parts. Reference numeral 304 denotes an answer input means including a radio communication means 305.

Hereinafter, a description will be given of an operation relating to an examination method using the individual examination execution device 301 according to the eighth embodiment.

When the play button 107 of the individual examination execution device 301 is pressed, exam question data stored in the exam question storage means 102 are reed out. The read exam question data are transmitted to the reproduction means 103, and outputted as audio to the headphones 108. Further, answers to the exam questions are not written on an a computer scoring answer sheet but are inputted by the answer input means 304, and the inputted answers are transmitted to a tally device (not shown) by the radio communication means 305, whereby collection of the answers are successively carried out.

It is possible to easily realize a system by adopting a semiconductor player as the individual examination execution device 301, a memory card as the exam question storage means 102, and a Bluetooth transceiver as the radio communication means 305, and placing a device that receives the answers transmitted from the respective semiconductor players, in the examination room.

As described above, in the individual examination execution device according to the eighth embodiment of the present invention, the answers are inputted in the individual examination execution device 301 by the answer input means 304, and radio communication is successively carried out by the radio communication means 305 to transmit the answers, whereby the answers are collected. Therefore, it becomes unnecessary to provide the respective examinees with answer storage means such as computer scoring answer sheets or answer storage means such as memory cards, and further, the time required until completion of examination can be reduced.

While in this eighth embodiment a Bluetooth transceiver is used as the radio communication means 305, the ratio communication means 305 is not restricted thereto. For example, any device having a radio communication function, such as a HomeRF (Home Radio Frequency) or a wireless LAN, may be employed.

Further, while in this eighth embodiment a semiconductor player is adopted as the individual examination execution device 301, an equipment that realizes the device 201 is not restricted thereto, and any equipment that can reproduce audio, such as a portable music player, may be adopted besides a radio cassette player and a semiconductor player.

### Embodiment 9

FIG. 14 is a diagram illustrating the construction of an individual examination execution device according to a ninth embodiment of the present invention. In FIG. 14, reference numeral 401 denotes an individual examination execution device according to the ninth embodiment, and the same reference numerals as those shown in FIG. 11 denote the same or corresponding parts. Reference numeral 403 denotes a unique number storage means in which a unique number that differs for each individual examination execution device 401 is stored, and reference numeral 404 denotes a decoding means that performs decoding using the unique number stored in the unique number storage means 403.

Hereinafter, a description will be given of an operation relating to an examination method using the individual examination execution device 401 relating to the ninth embodiment of the invention.

Initially, exam question data that are encoded using the unique number stored in the unique number storage means 403 are stored in the exam question storage means 102. During execution of examination, when the play button 107 of the individual examination execution device 401 is pressed, the encoded exam question data stored in the exam question storage means 102 are read out. The decoding means 404 obtains the unique number from the unique number storage means 403, and decodes the encoded exam question data. The decoded exam question data are transmitted to the reproduction means 103 and outputted as audio to the headphones 108.

It is possible to easily realize a system by using a semiconductor player as the individual examination execution device 401, a memory card as the exam question storage means 102, and a serial number that differs from semiconductor player to semiconductor player, as the unique number stored in the unique number storage means 403. In this case, when the serial number that is used for encoding of the exam questions stored in the memory card matches the serial number of the semiconductor player, the examinee can normally listen to the exam questions. However, when the serial number used for encoding of the exam questions does not match the serial number of the semiconductor player, the encoded exam questions are not correctly decoded, and the voice from the headphones does not make sense.

As described above, in the individual examination execution device according to the ninth embodiment, even when someone tries to reproduce the exam questions stored in the exam question storage means 102 with another individual examination execution device, he/she cannot listen to the exam questions because the unique number used for encoding of the exam questions does not match the unique number of the individual examination execution device, thereby avoiding such dishonesty that some examinee takes the recording media out of the examination room and lets someone listen to the exam questions to obtain answers.

While in this ninth embodiment serial numbers are employed as the unique numbers stored in the respective unique number storage means 403, the unique numbers are not restricted serial numbers, and any numbers may be employed so long as the respective individual examination execution devices 401 can be identified.

Further, while in this ninth embodiment a semiconductor player is adopted as the individual examination execution device 401, an equipment that realizes the device 401 is not restricted thereto, and any equipment that can reproduce audio, such as a portable music player, may be adopted besides a radio cassette player and a semiconductor player.

Furthermore, while in this ninth embodiment a memory card is adopted as the exam question storage means 102, the exam question storage means 102 is not restricted thereto, and for example, it may be any media in which data can be recorded, such as a hard disk or a mini disk.

### Embodiment 10

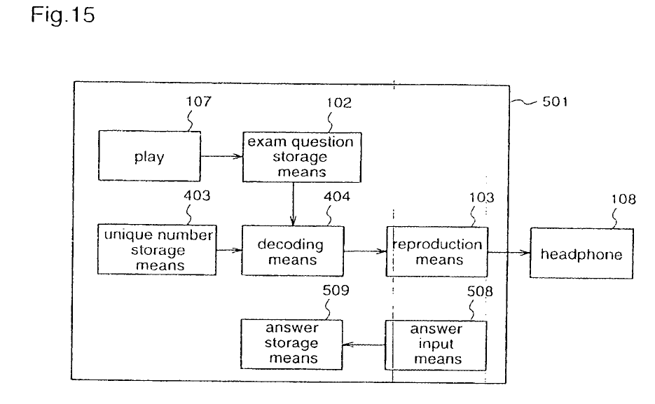

FIG. 15 is a diagram illustrating the construction of an individual examination execution device according to a tenth embodiment of the present invention. In FIG. 15, reference numeral 501 denotes an individual examination execution device according to the tenth embodiment of the invention, and the same reference numerals as those shown in FIG. 14 denote the same or corresponding parts. Reference numeral 508 denotes an answer input means, and numeral 509 denotes an answer storage means.

Hereinafter, a description will be given of an operation relating to an examination method using the individual examination execution device 501 according to the tenth embodiment constituted as described above.

Initially, exam question data that is encoded using the unique number stored in the unique number storage means 403 is stored in the exam question storage means 102. During execution of examination, when the play button 107 of the individual examination execution device 501 is pressed, the encoded exam question data stored in the exam question storage means 102 is read out The decoding means 404 obtains the unique number from the unique number storage means 403, add decodes the encoded exam question data. The decoded exam question data is transmitted to the reproduction means 103 and outputted as audio to the headphones 108. Further, answers to the exam questions are not written in a computer scoring answer sheet but are inputted using the answer input means 508 and then stored in the answer storage means 509.

It is possible to easily realize a system by using a semiconductor player as the individual examination execution device 501, a memory card as the exam question storage means 102 and the answer storage means 509, and a serial number that differs from semiconductor player to semiconductor player, as the unique number stored in the unique number storage means 403. In this case, when the serial number that is used for encoding of the exam questions stored in the memory card matches the serial number of the semiconductor player, the examinee can normally hear the exam questions. However, when the serial number used for encoding of the exam questions does not match the serial number of the semiconductor player, the encoded exam questions are not correctly decoded, and the voice from the headphones does not make sense. After the examination is finished, the memory card is swiped through the card reader to collect the answers, and the examinee can bring the memory card home.

As described above, in the individual examination execution device according to the tenth embodiment, even when someone tries to reproduce the exam questions stored in the exam question storage means 102 outside the examination room, he/she cannot reproduce the exam questions because the unique number of the individual examination execution device used for encoding of the exam questions does not match, thereby avoiding such dishonesty that some examinee takes the recording media out of the examination room and lets another person listen to the exam questions to obtain answers. Further, since the answers stored in the memory card are collected by the card reader, it is not necessary for the examinee to submit the memory card itself that holds the answers, and therefore, the examinee can take the memory card home for self-scoring. Accordingly, the precision of self-scoring can be significantly improved, and the time or the like until the examinee selects a school for which he/she takes an entrance exam can also be significantly reduced.

While in this tenth embodiment a semiconductor player is adopted as the individual examination execution device 501, an equipment that realizes the device 501 is not restricted thereto, and any equipment that can reproduce audio, such as a portable music player, may be adopted besides a radio cassette player and a semi-conductor player.

Furthermore, while in this tenth embodiment a memory card is adopted as the exam question storage means 102 and the answer storage means 509, any media in which data can be recorded, such as a hard disk or a mini disk, may be employed.

### Embodiment 11

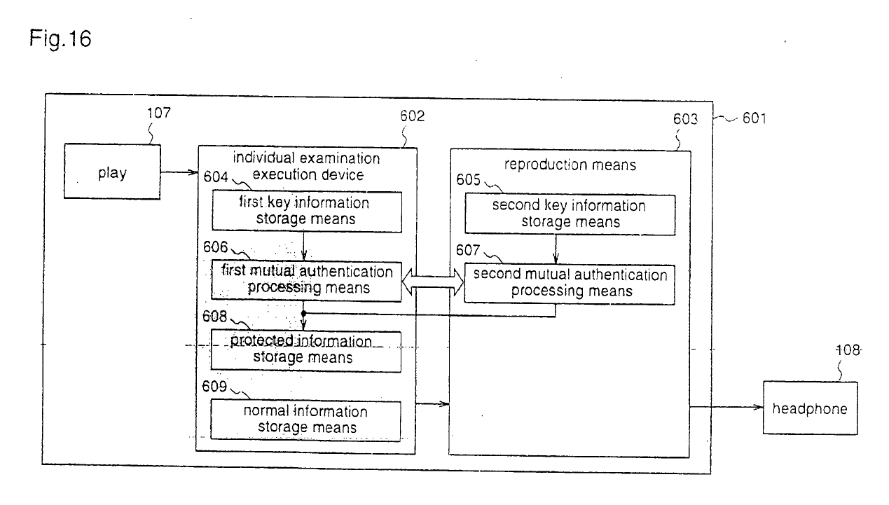

FIG. 16 is a diagram illustrating the construction of an individual examination execution device according to an eleventh embodiment of the present invention. In FIG. 16, reference numeral 601 denotes an individual examination execution device according to the eleventh embodiment, and the same reference numerals as those shown in FIG. 11 denote the same or corresponding parts. Reference numeral 602 denotes an exam question storage means, and numeral 603 denotes a reproduction means.

Further, in the exam question storage means 602, reference numeral 604 denotes a first key information storage means, numeral 606 denotes a first mutual authentication processing means that performs mutual authentication, numeral 608 denotes a protected information storage means from/in which reading/writing can be carried out after mutual authentication is established, and numeral 609 denotes a normal information storage means from/in which reading/writing can be carried out regardless of establishment of mutual authentication.

Further, in the reproduction means 603, reference numeral 605 denotes a second key information storage means in which key information is stored, and numeral 607 denotes if second mutual authentication processing means that performs mutual authentication.

Hereinafter, a description will be given of an operation relating to an examination method using the individual examination execution device 601 according to the eleventh embodiment that is constituted as described above.

Initially, exam questions are stored in the protected information storage means 608 in the exam question storage means 602. During execution of examination, when the play button 107 of the individual examination execution device 601 is pressed, a key that is common to the first key information storage means 604 of the exam question storage means 602 and the second key information storage means 605 in the reproduction means 603 is selected from these means.

Then, calculation is carried out using the key that is selected from the key information storage means of the first mutual authentication processing means 606 of the exam question storage means 602 and the second mutual authentication processing means 607 of the reproduction means 603. After the calculation, the result of calculation performed in the exam question storage means 602 is transferred to the reproduction means 603, and the result of calculation performed in the reproduction means 603 is transferred to the exam question storage means 602.

The exam question storage means 602 and the reproduction means 603 mutually compare the result of calculation performed by itself with the result of calculation performed by the other means, and when the results match, mutual authentication is established. After the establishment of mutual authentication, the reproduction means 603 reads the exam questions from the protected information storage means 608 in the exam question storage means 602, and outputs the questions as audio to the headphones 108.

It is possible to easily realize a system by using a copyright protective semiconductor player as the individual examination execution device 601, and a copyright protective memory card as the exam question storage means 602.

When the play button 107 is pressed, mutual authentication is carried out between the exam question storage means 602 that is implemented by a copyright protective memory card and the individual examination execution device 601 that is implemented by a copyright protective semiconductor player, and the exam questions are output as audio from the headphones 108. The copyright protective memory card such as a SD memory card is provided with, for copyright protection, means for confirming that a combination of a media and a host is an authentic combination, such as mutual authentication. In order to prevent reproduction with a commercially available semiconductor player, a special key for examination which is different from a key used for playing music that needs copyright protection is prepared in the copyright protective memory card and the copyright protective semiconductor player, whereby it is possible to restrict the combination of the copyright protective memory card that contains the exam questions and the copyright protective semiconductor player.

As described above, in the individual examination execution device according to the eleventh embodiment, the exam question storage means 602 and the reproduction means 603 are provided with the key information storage means 604 and 605, respectively, and the results of calculation performed using the key information are referred to each other in the respective means, and thereafter, reproduction of the exam questions stored in the protected information storage means 608 is allowed. Therefore, even when someone tries to reproduce the exam question storage means 602 outside the examination room, he/she cannot reproduce the exam questions outside the examination room because it is difficult to establish mutual authentication, thereby avoiding such dishonesty that some examinee takes the recording media out of the examination room and lets another person listen to the exam questions to obtain answers.

While in this eleventh embodiment a copyright protective semiconductor player is used as the individual examination execution device 601 and a copyright protective memory card is used as the exam question storage means 602, the individual examination execution device and the exam question storage means are not restricted thereto. Any equipment may be used so long as the individual examination execution device 601 can be specified.

While in this eleventh embodiment the exam question data is stored in the protected information storage means 608, the same effects can be obtained even when, as described for the ninth embodiment, a unique number and a decoding means are provided, the exam question data is encoded using the unique number, the encoded exam question data is stored in the normal information storage means 609, and the unique number is stored in the protected information storage means 600. When executing the examination, after establishment of mutual authentication, the unique number is obtained, and the encoded exam questions are decoded using the unique number and th decoding means, and then, the exam questions are outputted as audio from the reproduction means to the headphones.

### Embodiment 12

In the above-mentioned eleventh embodiment, the exam question storage means and the reproduction means are respectively provided with the key information storage means, and mutual authentication is performed between these means, and thereafter, reproduction of exam questions is permitted, thereby disabling reproduction of exam questions from the recording media which is taken out of the examination room. However, when individual examination is executed using the device constituted as described above, if reproduction of exam questions by the individual examination execution device is not carried out, it is impossible to judge whether the cause is non-establishment of mutual authentication or malfunction of the device, leading to a fear that considerable delay might occur during execution of individual examination.

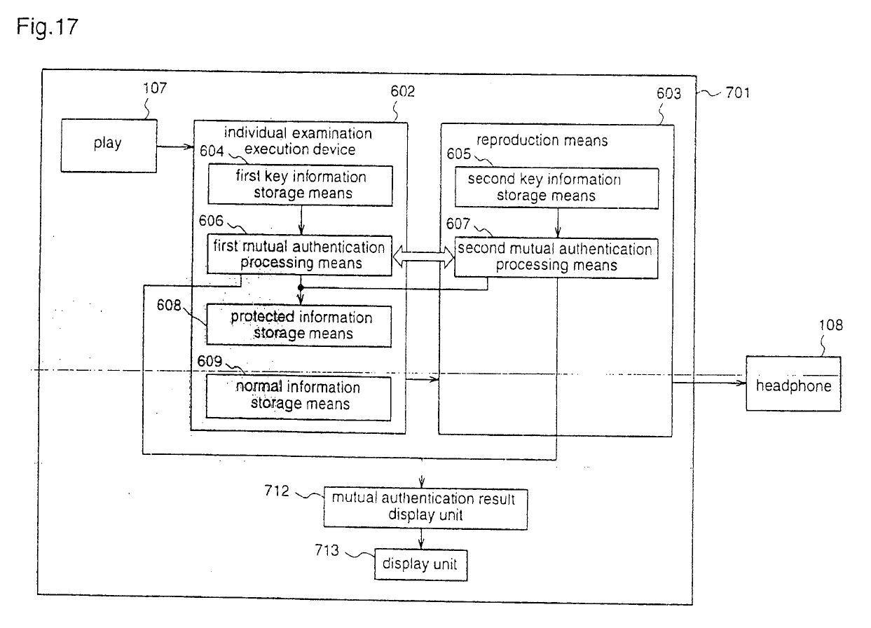

As a countermeasure against the above-mentioned problem, a twelfth embodiment of the present invention will be hereinafter described with reference to FIG. 17.

FIG. 17 is a diagram illustrating the construction of an individual examination execution device according to the twelfth embodiment In FIG. 17, the same reference numerals as those shown in FIG. 16 denote the same or corresponding parts, reference numeral 701 denotes an individual examination execution device, and numeral 712 denotes a mutual authentication result display means that displays the result of mutual authentication on a display unit 713.

A description will be given of an operation relating to an examination method using the individual examination execution device 701 according to the twelfth embodiment constituted as described above.

Initially, exam questions are stored in the protected information storage means 608 in the exam question storage means 602. During execution of examination, when the play button 107 of the individual examination execution device 601 is pressed, a key that is common to the first key information storage means 604 of the exam question storage means 602 and the second key information storage means 605 in the reproduction means 603 is selected from these means.

Then, calculation is carried out using the key that is selected from the key information storage means (604, 605) of the first mutual authentication processing means 606 of the exam question storage means 602 and the second mutual authentication processing means 607 of the reproduction means 603.

After the calculation, the result of calculation performed in the exam question storage means 602 is transferred to the reproduction means 603, and the result of calculation performed in the reproduction means 603 is transferred to the exam question storage means 602. The exam question storage means 602 and the reproduction means 603 mutually compare the result of calculation performed by itself with the result of calculation performed by the other means. When the results match, mutual authentication is established, and the reproduction means 603 reads the exam questions from the protected information storage means 608 in the exam question storage means 602, and outputs the exam questions as audio to the headphones 108. When the results do not match, reproduction of the exam questions is not carried out. However, since it is unclear whether the non-reproduction of the exam questions is caused by non-establishment of mutual authentication or malfunction of the device, the result of mutual authentication is displayed on the display unit 713 by the mutual authentication result display means 712.

It is possible to easily realize a system by using a copyright protective semiconductor player as the individual examination execution device 701, a copyright protective memory card as the exam question storage means 602, and a liquid crystal screen as the display unit 713.

As described above, according to the twelfth embodiment of the present invention, in the individual examination execution device that performs mutual authentication between the exam question storage means and the reproduction means, when reproduction of the exam questions is not performed in the examination room, it is judged whether the cause is malfunction of the device or incorrect combination, and the examination can be speedily started.

While in this twelfth embodiment a copyright protective semiconductor player is used as the individual examination execution device 701 and a copyright protective memory card is used as the exam question storage means 602, the individual examination execution device and the exam question storage means are not restricted thereto. Any equipment may be used so long as the individual examination execution device 601 can be specified.

Further, while in this twelfth embodiment a liquid crystal screen is used as the display unit 713, any display unit such as an organic EL display or a PDP may be employed.

### APPLICABILITY IN INDUSTRY

An individual examination execution device according to the present invention is provided with a question storage means in which exam questions are stored, a reproduction means for reproducing the exam questions stored in the question storage means, a sequence instruction means for instructing reproduction sequence of the exam questions, and a sequence data holding means that holds reproduction sequence instruction data to be given to the sequence instruction means, thereby enabling setting of exam question reproduction sequence for each individual examination execution device 11. Therefore, the individual examination execution device has the information recording/reproduction function, and is useful for reproduction exam questions and the like. Further, since the individual examination execution device realizes paperless examination, it is useful as an environment-friendly device.

1. An individual examination execution device comprising:
a question storage means in which exam questions are stored;
a reproduction means for reproducing the exam questions stored in the question storage means; and
a sequence instruction means for instructing a reproduction sequence of the exam questions.

2. An individual examination execution device as defined in claim 1 further including a sequence data holding means for holding reproduction sequence instruction data to be given to the sequence instruction means.

3. An individual examination execution device as defined in claim 1 further including,
an individual number input means for inputting an individual number possessed by a user of the individual examination execution device, and
a sequence data generation means for generating reproduction sequence instruction data to be given to the sequence instruction means, from the individual number.

4. An individual examination execution device as defined claim 1 further including,
a time instruction means for giving an instruction of operation to the sequence instruction means, and
a time data holding means for holding time data at which the time instruction means operates.

5. An individual examination execution device as defined in claim 1 further including,
an answer input means that is operable to input answers in association with reproduction of exam questions, and
an answer storage means in which answer data generated by the answer input means are stored.

6. An individual examination execution device as defined in claim 1 further including,
a battery power monitoring means for monitoring the remaining power of battery that operates the individual examination execution device, and
a progress degree storage means in which progress degree information of exam questions is stored when the remaining power of battery monitored by the battery power monitoring means becomes lower than a predetermined level.

7. An individual examination execution device comprising:
an exam question storage means in which exam questions are stored;
a reproduction means for reproducing the exam questions stored in the exam question storage means;
an individual information storage means in which individual information is stored; and
a display means for reading the individual information stored in the individual information storage means, and displaying the same.

8. An individual examination execution device comprising:
an exam question storage means in which exam questions are stored;
a reproduction means for reproducing the exam questions stored in the exam question storage means;
an answer input means which is operable to input answers in association with reproduction of the exam questions;
an answer storage means in which the inputted answers are stored; and
a radio communication means for transmitting the answers stored in the answer storage means by radio.

9. An individual examination execution device comprising:
an exam question storage means in which exam questions are stored;
a reproduction means for reproducing the exam questions stored in the exam question storage means;
an answer input means which is operable to input answers in association with reproduction of the exam questions; and
a radio communication means for successively transmitting the answers that are inputted from the answer input means.

10. An individual examination execution device comprising:
a unique number storage means in which a unique number that differs for each individual examination execution device is stored;
an exam question storage means in which exam questions that are encoded according to the unique number are stored;
a decoding means for reading the exam questions stored in the exam question storage means, and decoding the same; and
a reproduction means for reproducing the decoded exam questions.

11. An individual examination execution device as defined in claim 10 further including,
an answer input means which is operable to input answers in association with reproduction of the exam questions, and
an answer storage means in which the inputted answers are stored.

12. An individual examination execution device comprising:
an exam question storage means in which exam questions are stored as protected information;
a reproduction means for reproducing the exam questions stored in the exam question storage means; and
a mutual authentication processing means for confirming that the exam question storage means and the reproduction means are a predetermined combination;
wherein reproduction of the exam questions by the reproduction means is carried out when mutual authentication is confirmed by the mutual authentication processing means.

13. An individual examination execution device as defined in claim 12 further including a mutual authentication result display means for displaying the result of confirmation that the exam question storage means and the reproduction means are a predetermined combination.

14. An examination method using an individual examination execution device according to claim 1.

15. An examination method using an individual examination execution device according to claim 2.

16. An examination method using an individual examination execution device according to claim 3.

17. An examination method using an individual examination execution device according to claim 4.

18. An examination method using an individual examination execution device according to claim 5.

19. An examination method using an individual examination execution device according to claim 6.

20. An examination method using an individual examination execution device according to claim 7.

21. An examination method using an individual examination execution device according to claim 8.

22. An examination method using an individual examination execution device according to claim 9.

23. An examination method using an individual examination execution device according to claim 10.

24. An examination method using an individual examination execution device according to claim 11.

25. An examination method using an individual examination execution device according to claim 12.

26. An examination method using an individual examination execution device according to claim 13.
